(19) United States
(12) Patent Application Publication
(10) Pub. No.: US 2009/0183625 A1
(43) Pub. Date: Jul. 23, 2009

(54) Effects Control Apparatus And Method

(76) Inventor: Marek Konrad Sanders, London (GB)

Correspondence Address: Marek Sanders, 99 Gilmore Road, Lewisham, London, SE13 5AB, omitted

(21) Appl. No.: 12/350,865

(22) Filed: Jan. 8, 2009

(30) Foreign Application Priority Data
Jan. 9, 2008 (GB) 8015674

(51) Int. Cl. G10H 1/02

(52) U.S. Cl. 84/626

(57) ABSTRACT

The invention relates to a method and apparatus for digitally controlling analogue effect devices for musical instruments. The invention comprises an analogue effects device controlled by digital means such that the output sound from the musical instruments is of analogue sound quality.

### CROSS-REFERENCE TO RELATED APPLICATIONS

US publication 2005056142 teaches a system wherein digital processing is used to store and recall combinations of analogue devices. This is done by a control unit, which connects and disconnects the audio signal from a combination of attached analogue effects devices.

Many products that are available in the open market and that can be sourced on the Internet utilise similar technology as explained above. All these products offer functionality that can remember combinations and then connect or disconnect analogue effects by a single action such as a flick of a switch or touch of a button.

### BACKGROUND OF THE INVENTION

When playing live music with an amplifier, most musicians, especially guitarists, use effects devices, which change the way the amplified guitar sounds for different songs or sections of a single song. The signal travels along cables from the guitar through one, or more, effects devices, which alter the signal accordingly before it reaches the amplifier. Analogue effects foot pedals, (FIG. 1a), have been traditionally used for this, but they can be awkward to use and limited in what they can do. This is because each change on these devices requires an individual action from the guitarist. Therefore, when playing the guitar, the number of changes that can be incorporated largely depends on how quickly the guitarist can move his/her feet to control the pedals. Further, it is possible only to turn the effects on or off with the feet when playing the guitar, and fine-tuning the parameters on the pedals may not be possible. In most cases, an off-stage technician may be needed to manually adjust the parameters for the effects. Even so, it is well known that the output from these analogue effects devices provide a sound quality that is authentic, superior, and preferred by most professional guitarists.

In view of the impracticalities of analogue effects pedals, digital effects pedals such as the example shown in FIG. 1b have become increasingly common in recent years. These digital products work by processing the audio signal (analogue) from the guitar into binary code with an analogue to digital (AD) Converter. They are much more versatile than analogue effects devices, allowing a much wider variety of effects parameters to be activated or changed with much greater ease. For example, many parameters can be changed with one press of a foot pedal. However, a commonly recognised problem that musicians and professionals in the music industry are being faced with is that when the sound is digitally processed the quality of the output sound is reduced. This is because even though the analogue signals can be quite easily converted; when data is digitally processed some information is always lost. This will always be the case no matter how precise and advanced digital processing becomes, since an analogue wave format is smooth as opposed to the binary wave format that is obtained for digital signals. This loss of information results in an output sound that is regarded as unpleasing to the ear, and inferior to the desired sound quality. Therefore, while they do allow versatile control of effects parameters when compared to their analogue counterparts, a digital effects device is no match for the quality of sound associated with analogue effects devices.

There do exist a few effects systems in the prior art that have been based on both digital and analogue technology. For example, US publication 2005056142 teaches a system wherein digital processing is used to store and recall combinations of analogue devices. This is done by a control unit, which connects and disconnects the audio signal from a combination of attached analogue effects devices.

Many products that are available in the open market and that can be sourced on the Internet utilise similar technology as explained above. All these products offer functionality that can remember combinations and then connect or disconnect the analogue effects by a single action such as a flick of a switch or touch of a button. However, none of these products can actually control parameters on the analogue effects device itself.

Therefore, the present invention addresses the above issue by providing an apparatus and method that allows a digital control unit to control the parameters on analogue effects devices in such a way so as to maintain that the output is in the form of analogue signals originating from the analogue effects device itself. The invention thereby converges the versatility of digital controls with the superior sound quality associated with analogue effects pedals.

### BRIEF SUMMARY OF THE INVENTION

The present invention relates to an effects control apparatus and a method for controlling the effects of a musical instrument using the same. More specifically, the invention relates to an apparatus and method for providing digital control for analogue effects devices, wherein the analogue output from the analogue effects device is maintained.

According to a first aspect, the present invention provides an apparatus for digitally controlling at least one analogue effects device for musical instruments, said system comprising an adaptor suitable for attaching to control means of the analogue device, said adaptor being connected to a digital control unit arranged to configure various combinations of effects required for a particular output signal, wherein operation of said adaptor is controlled by the digital control unit, whereby the control means of the analogue effects device is moved to a position corresponding to a position determined in accordance with control signals received from the digital control unit, such that output from the system is obtained from the analogue effects device in an analogue format.

The invention also provides a method for digitally controlling analogue effects for a musical instrument comprising the steps of: connecting an analogue effects device to an adaptor, said adaptor being controlled by control signals from a digital control unit; creating and processing instructions within the digital control unit for issuing the control signals; triggering the movement of control dials on the analogue control means to a position according to the digital control signal received by the adaptor for modifying the effects parameters in said analogue effect control device; and obtaining output effects in the form of an analogue signal from the analogue effects device. The invention thereby solves the problem illustrated in the background of the invention, by converging the versatility of digital controls with the superior sound quality associated with analogue effects pedals.

According to a further aspect, the invention also provides an apparatus for digitally controlling analogue effects for musical instruments comprising a digital control unit arranged to configure various combinations required for a plurality of effects, said control unit being provided with one or more analogue effects generators whereby operation of said analogue effects generator is controlled by the control unit, said apparatus arranged to be connected to a musical instrument such that output from the musical instrument is modified by the or each musical effects generator.

### BRIEF DESCRIPTION OF THE SEVERAL VIEWS OF THE DRAWING

Embodiments of the present invention are described below in more detail, by way of example, with reference to the accompanying drawings in which:

FIG. 1a shows the connection of analogue effects pedals with a guitar and amplifier, as known from the prior art.

FIG. 1b shows the connection of a digital effects box with a guitar and amplifier, also known from the prior art.

FIG. 2a shows a representation of the digitally controlled analogue effects apparatus according to the present invention.

FIG. 2b shows the apparatus of FIG. 2a in connection with a guitar and amplifier, depicting the implementation of the present invention.

FIG. 3 shows a representation of the working components of the digitally controlled analogue effects apparatus according to the present presentation.

FIGS. 4a, 4b and 4c depict examples of mechanisms that could be incorporated for the implementation of the present invention.

### DETAILED DESCRIPTION OF THE INVENTION

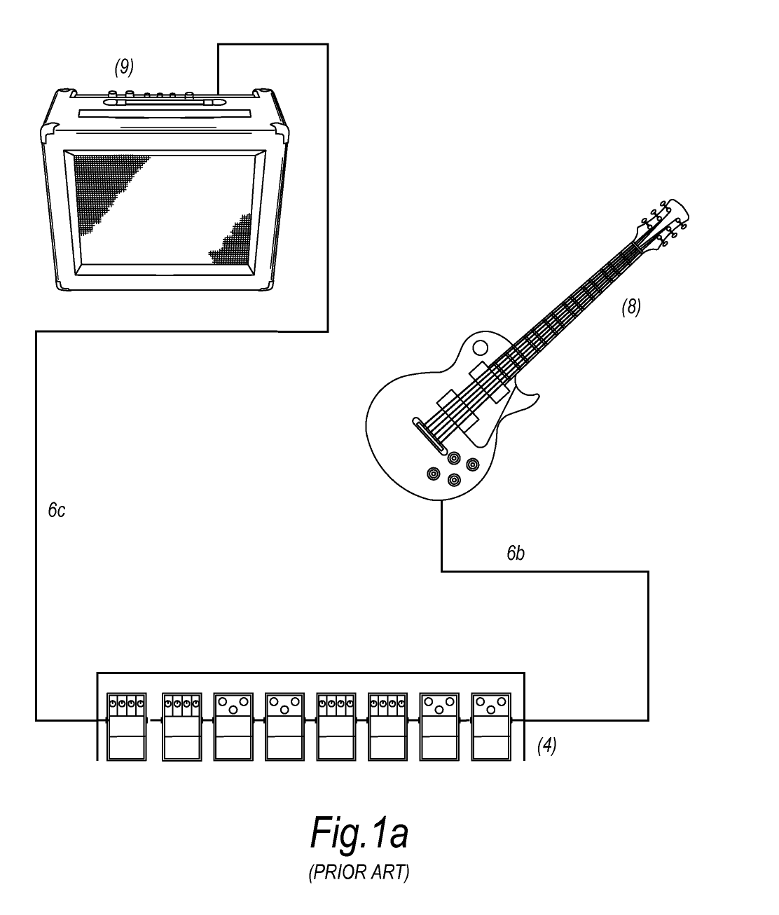

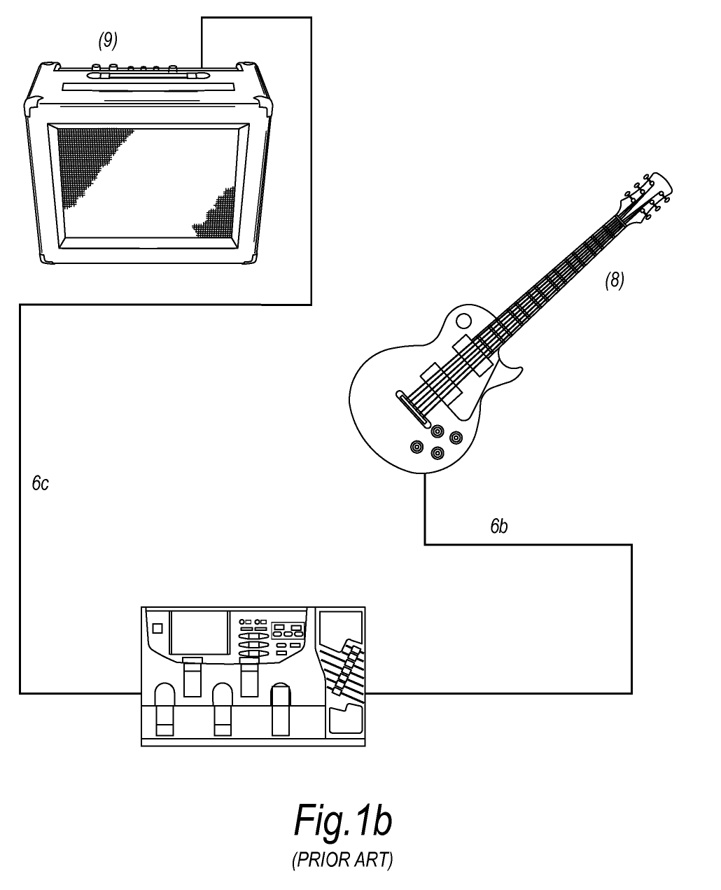

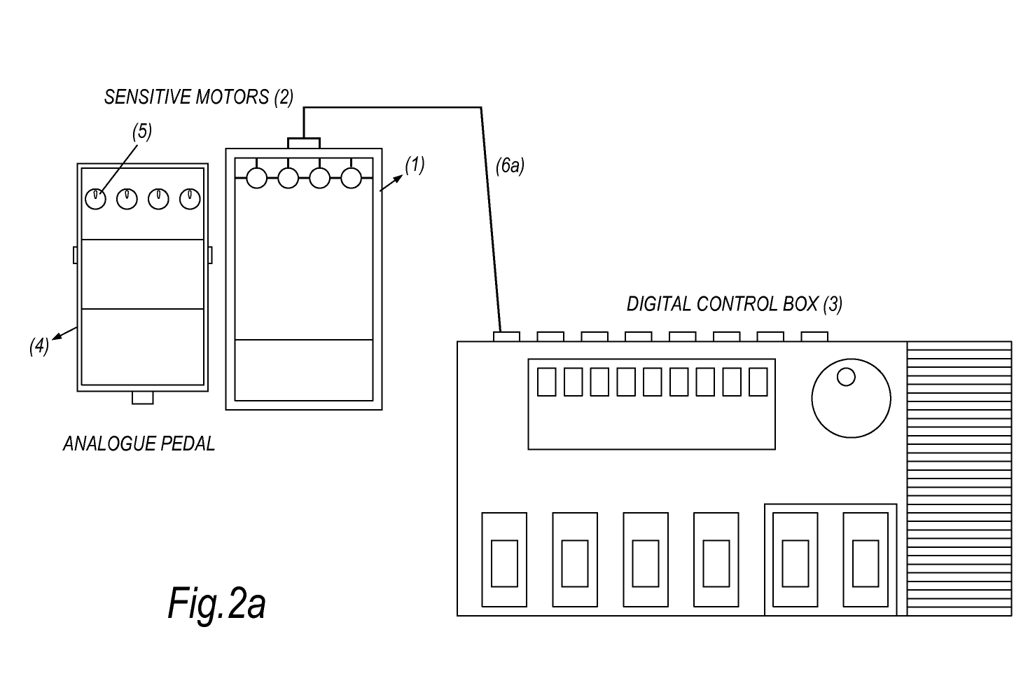

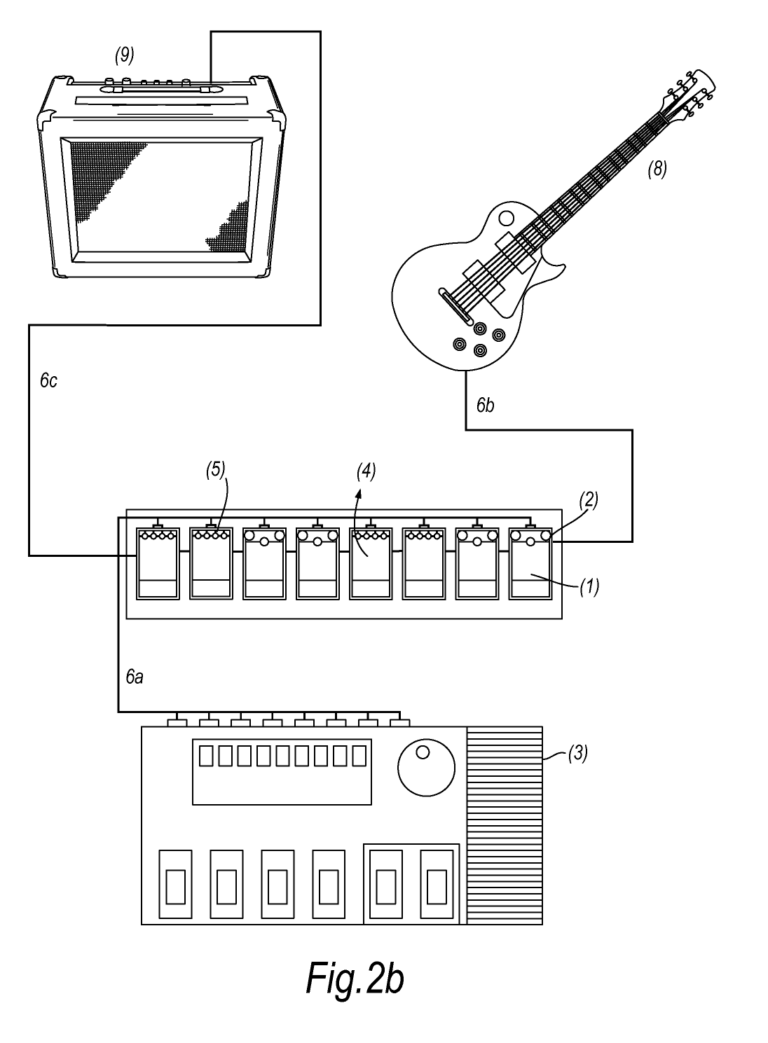

As seen from FIGS. 1a and 1b, for the traditional connection of any effects device, a guitar (8) or any other musical instrument is connected to the analogue or digital effects pedal box. The output of these pedals is in turn connected to an amplifier (9). This same connection structure can be incorporated for the present invention too, as seen in FIG. 2b. However, in order to implement the internal connections for effects control apparatus of the present invention, the arrangement and connections within the effects pedals and between the effects pedals and control unit is different from the connection in the traditional systems. An example of the connection structure for the effects control apparatus of the present invention can be seen in FIG. 2a.

Even though the embodiments shown in the figures on which the following description is based are related to effects pedals for guitars, it will be appreciated that the application of the apparatus and method for effects control relating to the invention is not restricted to guitars alone, and can be used in a similar manner for controlling the effects of other musical instruments as well, such as other string instruments such as violins, cello, etc. and may also be used for pianos and musical keyboards.

The effects control apparatus according to the present invention can be used along with any available traditional analogue effects pedal. As can be seen from FIG. 2a, the apparatus according to the present invention comprises an adaptor (1) that may be in the form of a bracket or sleeve that is arranged to be suitable for slipping onto a traditional analogue effects pedal (4). The apparatus comprises of a plurality of such adaptors (1) that can be placed on a plurality of analogue effects pedals (4) arranged together as seen in FIG. 2b. As seen in this figure, this plurality of adaptors (1) on the analogue pedals (4) are connected to a digital control unit (3).

The sound from traditional analogue effects pedals are usually modified or changed by physically turning knobs (5) on the pedals (4). Therefore, in order to maintain the output sound signals as analogue signals as desired by the invention, it will be necessary to effect the physical tuning of the analogue pedals (4) by turning the knobs (5). This is achieved by movable means (2), as seen in FIG. 2a that is part of or affixed to the adaptors (1). These are preferably cylindrical in shape, so that they can easily be attached to the knobs (5) on the pedals (4). It is also preferable that a gripping means is provided on the movable means (2) in order to prevent accidental loosening or slipping of these movable means (2). Alternatively, these means (2) may be made from a gripping substance such as rubber etc. The movement of these movable means (2) that in turn will effect movement of the knobs (5) of the analogue pedals (4) is controlled by the digital control unit (3). The movement of means (2) is effected by precise motors that preferably have a high sensitivity arranged on the under surface of each of these means (2). These motors are triggered by the digital control unit (3), which thereby results in the rotation of the control knobs (5) to manage the output sound from the analogue effects device (4).

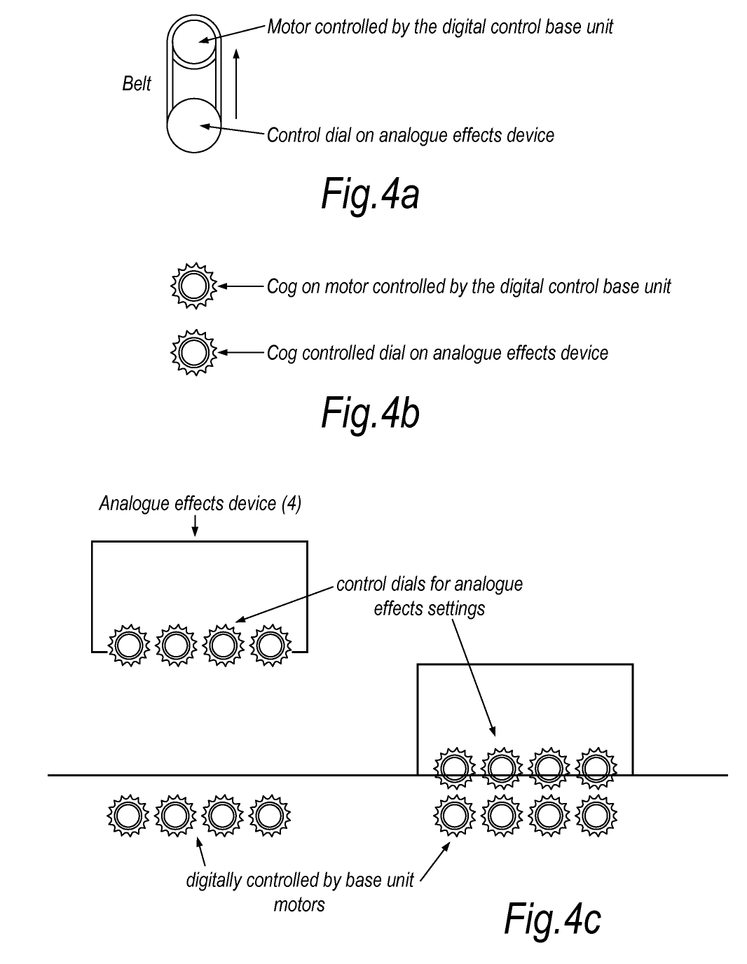

It will be appreciated that even though the invention has been described as being used along with traditional analogue pedals having control dials in the form of knobs (5), the invention is not limited to being used only along with a separate analogue. The analogue device (4) and dials (5) and also the movable means (2) can also be modified, if required to incorporate other forms of tuning mechanisms such as precision gear systems, cogs, transmission belts etc., which would also serve the function of controlling the sound signals output from the effects device (4). Some of these alternatives can be seen in FIGS. 4a-4c, the description of which is provided later on in this document.

One such implementation of the invention may be such that the analogue effects device is incorporated along with the digital control unit itself, specially designed to work in sync with the controls in the digital unit. In this case the effects device may be in a form of one or more analogue generators provided incorporated with the digital control unit, wherein signals from the control unit directly affect the generator. The effects generator may be controlled by mechanical means, signals etc. FIG. 4c shows a representation where similar types of cog type motors are provided on the digital control unit, as well as on the generators such that the movement of the cogs on the digital unit in turn directly moves the cogs of the analogue generator. Other possible implementations are explained later in this document.

In this implementation the guitar, or any other musical instrument can provide an output signal, which is analogue, but digitally controlled by the control unit. This does not require having an extra set of analogue pedals or a separate pedal box containing the traditional analogue pedals, thus resulting in providing the same superior quality analogue sound effects without additional wiring for the pedal boxes.

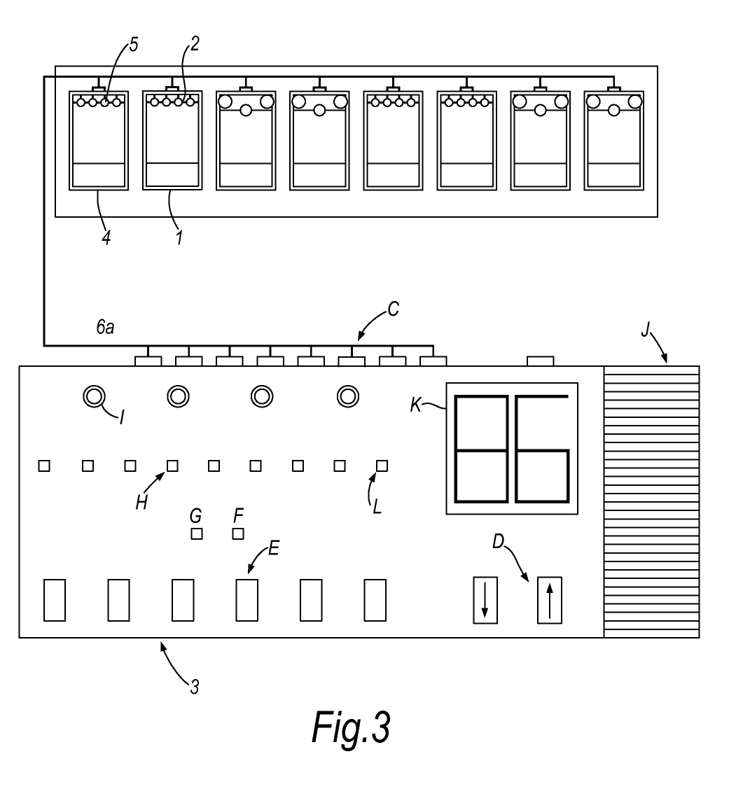

The working of the apparatus, under the control of the digital control unit (3) is seen in FIG. 3 is described as follows in relation to this figure:

In FIG. 3 it is seen that the adaptor (1) attaches to an analogue effects device (4). The adaptor incorporates movable means (2), shown here in the form of cylinders or hollowed dials that can rotate (2). These may be made of rubber or another material with suitable grip that press against the control knobs (5) of the analogue effects device (4). The motors (2) connect to the digital base unit (C). Although FIG. 3 shows that it is possible to connect eight adaptors, according to the requirements of the guitarist, different embodiments could allow for more, or less.

A patch is defined as the particular effect or combination of effects and settings for a particular sound or effect, and this term is well known in the music industry. This patch is arranged to be stored and later recallable at the flick of a switch or press of a foot pedal etc. A bank is defined as a number usually designated for one song in a performance. There may be are several patches (i.e. for example six, as shown in FIG. 3) that can be saved for each bank. This term is also well known in the industry.

In order to assign effects settings to a patch in the present invention, a user will first select a bank by using the bank switches (D). It is preferably that these switches (D) can scroll up and down through the bank numbers that can be indicated on the left hand side of a screen (K), such as an LCD display. Having selected the desired bank (for example, in FIG. 3, bank 8 is selected), the patches in that bank are then selected by pressing one of the patch selector pedals (E), which correspond to a patch number on the right hand side of the LCD screen (K) (in FIG. 3, patch no. 6).

An edit button (G) on the control unit (3) is then pressed, allowing the patch to be prepared. An analogue effects device (4) is then selected by pressing the corresponding button for the device in row H indicated on the unit (3) in FIG. 3. Once selected, desired settings on the control motors (not shown) can be set by adjusting the dials (1) on the base unit which move the corresponding movable means (2), which in turn move control dial (5) on the analogue devices (4). More than one effects device can be thus selected for a particular patch.

Once the desired analogue devices, effects and settings have been assigned to the patch i.e. the right alteration of the guitar sound has been found, the patch is stored by pressing a store button (F) on the base unit. This finished patch is now saved to a number (86 in the case of FIG. 3).

The apparatus according to the present invention also allows direct real-time control of a movable means (2) on any attached analogue effect device (4), using the pedal (J), which may be operated by hand, or foot, according to the user's preference, while the user is performing with their guitar. To do this, when a bank and patch is selected, the user presses the edit button (G) and then presses the pedal (J) to assign it to the patch. The user then assigns the patch to an analogue device (4) by pressing the corresponding button in row H to assign the setting to a particular device (4), and assigns a corresponding means (2) on the selected device (4) by pressing a button on dials (I). Another real time button (L) is pressed, then (L) to save it and the pedal (J) is now assigned to directly control the selected motor on adaptor (1) when the patch is later on selected.

In order to recall a desired patch during a performance, the user may repeatedly press the bank selector pedals (D) on the base unit to find the desired bank. Once the desired bank is selected (shown to the left of the LCD screen (K)), the desired patch is recalled by pressing the relevant pedal in row (E). This instantly adjusts the controls on all the designated analogue effects devices to the pre-programmed settings in that patch, or it instantly assigns the real-time control pedal (J) to the pre-selected analogue effects dial (5) by effecting movement of movable means (2).

The precision motors and/or the gripping means that are incorporated in the dials (2) on the adaptors (1) can be implemented by different mechanisms that can achieve the same effect, i.e. movement of the knobs (5) on the analogue devices (4). One such implementation is seen in FIG. 4a. Here, instead of using a cylinder (2) that touches and grips the knobs (5) on the analogue effects device, an alternative would be to have the rotating cylinder (2) connected to the analogue dial (5) by a belt, instead of touching the dial. This embodiment allows the apparatus of the present invention to accurately adjust the analogue effects control dial (5), but with less chance of slipping over time.

An alternative to the embodiment shown in FIG. 4a is to have a mechanical part, such as a cog, instead of the gripping cylinder (2) as seen in FIG. 4b, directly linked to another cog which can be placed on the analogue effects device, in place of the control dial (5).

Another alternative to the FIGS. 4a and 4b is seen is FIG. 4c wherein specially designed analogue effects devices are provided that may attach directly to the digital control unit (3), or attach to a separate rack of ports controlled directly by the unit (3). In this case, the analogue signal would still travel from the guitar, through the effects devices, to the amplifier, but would be directly controlled by the digital unit (3) using mechanical means such as the motorised cogs seen in FIG. 4b.

It is preferred that the bracketed pedals (I, 4) can be boxed away and thus prevented from wear and tear. The pedals may be visible through a transparent cover.

In a further embodiment it is preferred that a small camera such as a USB camera device can to be attached to the analogue device or the bracket. This camera will be capable of viewing the movements of the rotating parts on the analogue device (2, 5), whose movements can be emphasised with a colourful display, and can be viewed on a separate device, such as a computer. This display result may be used for review purposes, or for visual effects.

In addition to the bank and patch numbers on the LCD screen (K) of FIG. 3, it is envisaged that additional information, such as names for each patch or visual representations of the effects units can be pre programmed and displayed on the screen. This display may also allow for feedback from the camera.

In addition to the USB camera, it is envisaged that the apparatus according to the invention may have further ports for added functionally such as for a memory stick and a USB device etc, to allow patches to transfer to other devices such as computers using tailored software or the internet, in order to synchronise these patches with known sequencers such as Pro-Tools, Cubase, or Logic. Etc. This could make it possible for example to upload patch settings shared over the Internet or available as downloads.

1. An apparatus for digitally controlling at least one analogue effects device (4) for musical instruments, said apparatus comprising an adaptor (1) suitable for attaching to control means (5) of the analogue device, said adaptor being connected to a digital control unit (3) arranged to configure various combinations of effects required for a particular output signals wherein operation of said adaptor (1) is controlled by the digital control unit (3), whereby the control means (5) of the analogue effects device (4) is moved to a position corresponding to a position determined in accordance with control signals received from the digital control unit (3), such that output from the system is obtained from the analogue effects device (4) in an analogue format.

2. The apparatus as claimed in claim 1 wherein said adaptor is provided with movable means (2) for attaching with the control means (5) on the analogue effects device (4).

3. The apparatus as claimed in claim 2 wherein said movable means (2) are movable mechanical devices.

4. The apparatus of claim 2 wherein said movable means (2) comprise precision motors capable of a rotating movement, wherein said movement of said motors is capable of effecting operation of the control means (5) on the effect device (4).

5. The apparatus of claim 2 wherein said movable means (2) in the form of a rotating dial provided with a belt arrangement for attaching with the control means (5) of the device (4), wherein the movement of the dial and belt arrangement effect the turning of the control means (5).

6. The apparatus of claim 2 wherein said movable means is in the form of a cylinder provided with gripping means for attaching with control means (5), wherein movement of the cylinder effects the turning of the control means (5).

7. The apparatus of claim 2 wherein said movable means are in the form of a mechanical cog, said cog being arranged for attaching with a similar cog provided on the control means (5) to effect turning of said control means (5).

8. The apparatus as claimed in any preceding claim wherein said adaptor (1) is in the form of a bracket.

9. The apparatus as claimed in any preceding claim wherein the control signals from the digital control unit (3) are sent to the one or more analogue effects device via a cable (6a).

10. The apparatus as claimed in any preceding wherein said control means (5) is in the form of knobs (5) provided for fine adjustments of effects provided by the analogue effects device (4).

11. The apparatus as claimed in any of the preceding claims wherein said one or more analogue effects devices (4) are arranged in a pedal box.

12. The apparatus as claimed in any proceeding claim wherein said instrument is a guitar (8) such that output signals from the guitar (8) is connected to the one or more analogue effect devices (4) via a cable (6b), and the analogue output signal from the analogue effects devices (4) are connected to an amplifier (9) via another cable (6c).

13. A method for digitally controlling analogue effects for a musical instrument comprising the steps of:
connecting an analogue effects device to an adaptor, said adaptor being controlled by control signals from a digital control unit;
configuring instructions within the digital control unit for issuing the control signals;
triggering the movement of control dials on the analogue control means to a position according to the digital control signal received, by the adaptor for modifying the effects parameters in said analogue effect control device; and
obtaining output effects in the form of an analogue signal from the analogue effect device.
